(19) United States
(12) Patent Application Publication
(10) Pub. No.: US 2013/0313238 A1
(43) Pub. Date: Nov. 28, 2013

(54) LASER MACHINING SYSTEM WITH AIR FLOW EXTRACTION

(71) Applicant: Trumpf Laser-und Systemtechnik GmbH, Ditzingen (DE)

(72) Inventors: Andreas Twisselmann, Rutesheim (DE); Dietrich Sauter, Metzingen (DE)

(73) Assignee: Trumpf Laser-und Systemtechnik GmbH, Ditzingen (DE)

(21) Appl. No.: 13/956,549

(22) Filed: Aug. 1, 2013

Related U.S. Application Data
(63) Continuation of application No. PCT/EP2012/000440, filed on Feb. 1, 2012.

(30) Foreign Application Priority Data
Feb. 1, 2011 (DE) 102011003426.9

(51) Int. Cl. B23K 26/14

(52) U.S. Cl. CPC B23K 26/1405
USPC 219/121.84; 219/121.86

(57) ABSTRACT

A laser machining system includes a workpiece support, a laser machining unit arranged above the workpiece support and for machining a workpiece located on the workpiece support, at least one extraction opening beneath the workpiece support, and an enclosure separating the workpiece support, the laser machining unit and the at least one extraction opening from an external environment. The enclosure includes at least one air inflow opening arranged above the workpiece support and relative to the at least one extraction opening such that, during operation of the laser machining system, a pressure difference between the air inflow opening and the at least one extraction opening establishes a flow of air between the workpiece support and the laser machining unit, in which the flow of air separates the interior of the enclosure into a laser machining area beneath the flow band and a laser free area above the flow band.

### CROSS REFERENCE TO RELATED APPLICATIONS

This application is a continuation of and claims priority under 35 U.S.C. §120 to PCT Application No. PCT/EP2012/000440 filed on Feb. 1, 2012, which claimed priority to German Application No. 10 2011 003 426.9 filed on Feb. 1, 2011. The contents of both of these priority applications are hereby incorporated by reference in their entirety.

### TECHNICAL FIELD

The present disclosure relates to a laser machining system according to the preamble of patent claim 1.

### BACKGROUND

An example of a laser machining system capable of extracting dust and/or fumes can be found in U.S. Pat. No. 6,229,112 B1. The laser cutting system described in that patent has within the machine base means arranged in chambers for extracting dust and/or fumes and is encased, apart from an inflow opening, by a machine enclosure. The low pressure that is generated inside the laser machining system during extraction is equalized by the inflow opening. The inflow opening is formed at the height of the workpiece support. The air flow that is generated assists extraction of dust and/or fumes beneath the workpiece. Further secondary inflow openings arranged in the roof of the enclosure ensure that air flows through the whole of the interior of the enclosure in order to avoid the accumulation of particles in so-called “dead areas”.

Because it is necessary when using this extraction technique for air to flow through the whole of the interior of the machine enclosure, the extraction power of the suction unit (exhaust system) has to be very high. Due to the large extraction volume, such a system gives rise to disadvantages with respect to installation space and costs. In addition, residual contamination of the components of the laser machining system located inside the machine enclosure, such as optical components and mechanical guides, leads to high maintenance and operating costs as a result of breakdown and wear. Furthermore, residual contamination may additionally represent a health risk as a result of excessively high dust concentrations in the air.

### SUMMARY

The present disclosure describes laser machining systems with air flow extraction that, at least in some implementations, addresses some or all of the foregoing issues.

In general, in at least one aspect, the present disclosure covers laser machining systems with air flow extraction in which the interior of the housing is spatially separated by a flow of air into two areas: a laser machining area, through which air flows and in which dirt particles and process gases/fumes are produced; and an area free of laser interaction, through which air does not flow and which is kept free of dirt particles and fumes. In this way, air flow and extraction do not occur in the entire interior of the enclosure but only in the laser machining area. This allows cost savings to be achieved as a result of smaller suction units (exhaust systems) necessary or greater efficiency with the same suction units. Maintenance and operating costs may also be lower as a result of the reduction in wear and breakdown of individual machine components.

In some implementations, the flow band is deflected by a deflection device so that the flow band forms a circular flow that encloses the laser machining area to keep dirt particles and fumes inside the circular flow until they are extracted by way of an extraction opening.

Further advantages will become apparent from the following description and the associated drawings. The features and implementations described herein can each be used on their own or in arbitrary combinations. The embodiments shown and described are not to be understood as being a conclusive list but instead are of an exemplary nature for illustrating the invention.

### BRIEF DESCRIPTION OF THE DRAWINGS

FIG. 1 is a schematic that shows a first embodiment of a laser machining

FIG. 2 is a schematic that shows the flow pattern of the flow band shown in FIG. 1.

FIGS. 3, 4 and 5 are schematics, each of which shows a different embodiment of a laser machining system.

Like reference symbols in the various drawings indicate like elements.

### DETAILED DESCRIPTION

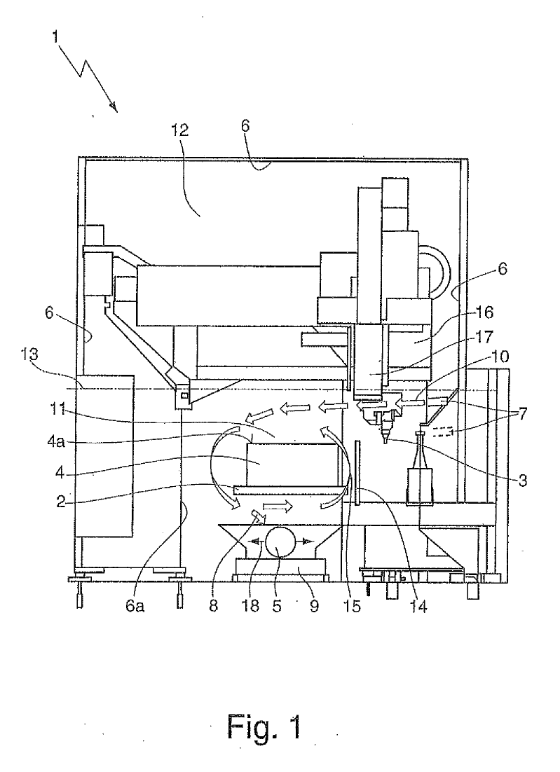

The laser machining system 1 shown in FIG. 1 includes a workpiece support 2, a laser machining unit (e.g., a laser machining head) 3 arranged above the workpiece support 2 for machining a workpiece 4 located on the workpiece support 2, an extraction opening 5 provided beneath the workpiece support 2. The laser machining system 1 also includes an enclosure 6, which separates the workpiece support 2, the laser machining unit 3 and the extraction opening 5 from an external environment and which is opened to the external environment only by an air inflow opening 7. The fumes and dust produced during the laser machining of the workpiece 4 are extracted by way of the extraction opening 5 (arrow 8 indicating the direction of flow). Air flows in by way of the inflow opening 7 in order to equalize the low pressure that is generated inside the enclosure 6 during extraction. The extraction opening 5 is connected to a waste container 9 for collecting the waste material, such as, for example, slag particles, extracted during machining As an alternative to the inflow opening 7 in FIG. 1 that is fixedly attached to the enclosure 6, the inflow opening can be mounted on the enclosure 6 to be vertically displaceable by means of a suitable drive (not shown). The laser machining unit 3 is arranged on a displacement unit 16 which is moveable parallel to the plane defined by the workpiece support 2 and is in the form of, for example, an arm which can be moved over the workpiece support 2. In addition, the laser machining unit 3 can also be adjustable in the vertical direction, that is to say perpendicular to the workpiece support 2, by way of a slide 17 provided on the displacement unit 16.

The air inflow opening 7 is located laterally next to the workpiece support 2 and is arranged in the vertical direction between the workpiece support 2 and the displacement unit 16, in particular above the upper edge 4a of the workpiece, in such a manner that the outline of the displacement unit 16 does not impede the flow band of incoming air that is to be formed. Preferably, the air inflow opening 7 is located at least from about 100 to about 200 mm beneath the displacement unit 16. During operation, the air flowing in by way of the inflow opening 7 forms, in conjunction with the extraction that is achieved through the extraction opening 5, an air flow band 10 between the workpiece 2 and the laser machining unit 3 that is inclined downwards slightly. In this way, the pressure difference between the air inflow opening and the extraction opening establishes a flow of air (air flow band) 10 between the workpiece support 2 and the laser machining unit 3. The inclination of the air flow band 10 can be increased, if the inflow opening 7 is likewise inclined. The inclination of the air flow band 10 is preferably such that the air flow band 10 does not strike the vertical enclosure portion 6a perpendicularly. Alternatively, a horizontal air flow band 10 can be introduced into the enclosure. In this case, the enclosure portion 6a should be inclined relative to the air flow band 10 in such a manner that a downwardly directed air flow band 10 is obtained. By means of the air flow band 10, the interior of the housing enclosure 6 is separated into a laser machining area 11, which is located beneath the flow band 10, and an area 12 free of laser interaction, which is located above the flow band 10, as indicated by the dot-and-dash line 13. By positioning the air inflow opening 7 approximately at the height between the displacement unit 16 and the laser machining unit 3, the incoming air flow covers the entire laser interaction zone on the workpiece 4 and accordingly separates the interior of the enclosure 6 into the laser machining area 11, through which air deliberately flows, and the area 12 free of laser interaction, through which air does not flow. Owing to the flow band 10, the dirt particles and fumes produced during the laser machining of the workpiece 4 remain in the laser machining area 11, where they are extracted. As a result, the extraction efficiency is increased significantly and the residual contamination by dirt particles and fumes of the area 12 free of laser interaction is reduced markedly.

As is shown in FIG. 1, the flow band 10 can be deflected by means of a deflection device, which is formed on the left-hand side in FIG. 1 by a vertical enclosure portion 6a and on the right-hand side by a separate vertical deflection plate 14, to form a circular flow 15 that encloses the laser machining area 11. In that manner, the dirt particles and fumes formed during the laser machining of the workpiece 4 remain trapped within the circular flow 15 until they are extracted by way of the extraction opening 5, which is open in the direction transversely to the air flow band 10.

As is shown by a broken line in FIG. 1, multiple air inflow openings 7 can be provided at different heights. The air inflow openings 7 can be activated, i.e. opened or closed, individually or in combination to form flow bands 10 arranged at different heights. In the case of a vertically adjustable laser machining unit 3, the multiple air inflow openings 7 can be opened or closed by means of flaps, for example, in dependence on the vertical position of the laser machining unit 3, to form flow bands 10 arranged at different heights. As is indicated in FIG. 1 by a twin-headed arrow 18, the extraction opening 5 can be arranged beneath the workpiece support 2 in such a manner that it is also displaceable in the horizontal direction relative to the inflow opening 7.

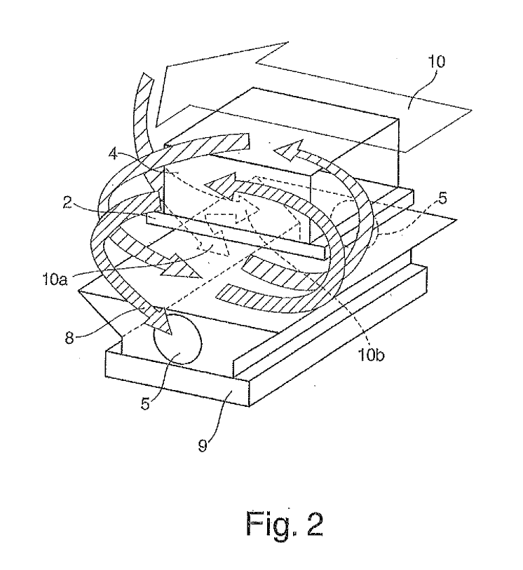

FIG. 2 shows schematically the flow pattern of the flow band 10. After the flow band 10 has flowed over the top of the workpiece 4, it is extracted by two extraction openings 5 provided on both sides of the flow band 10 which open transversely to the flow band 10. The flow band 10 is thereby divided in the middle into two flow halves 10a, 10b, which are each extracted by the extraction openings 5. The flow of air 10 thereby forms in the direction of each of the extraction openings 5 an eddy flow that encloses the laser machining area 11, as is shown in FIG. 2 only for one flow half 10a.

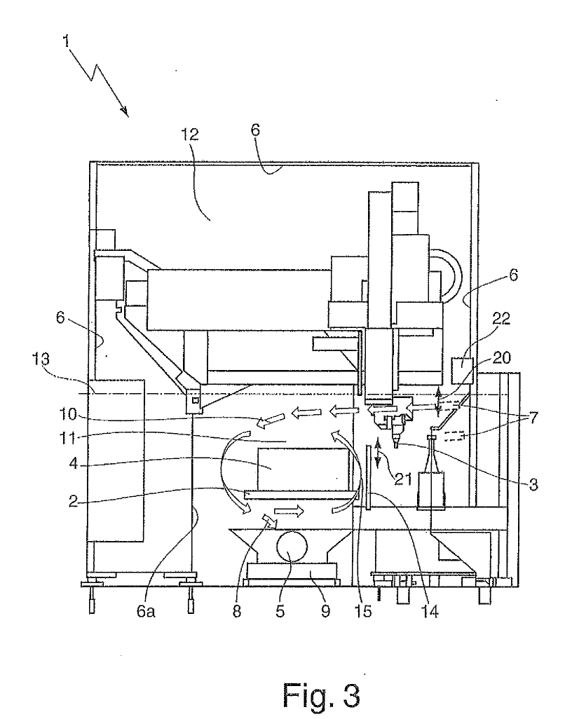

The laser machining system 1 shown in FIG. 3 differs from the laser machining system of FIG. 1 only in that the laser machining unit 3 and the inflow opening 7 therein are each vertically displaceable (twin-headed arrows 20, 21). Mechanically or by means of a control unit 22, the vertical position of the inflow opening 7 can be controlled based on the vertical position of the laser machining unit 3. For example, the vertical position of the inflow opening 7 can be adjusted using a control unit 22 based on the vertical position of the laser machining unit 3, machining parameters and/or the workpiece to be machined (e.g., dimensions and/or material).

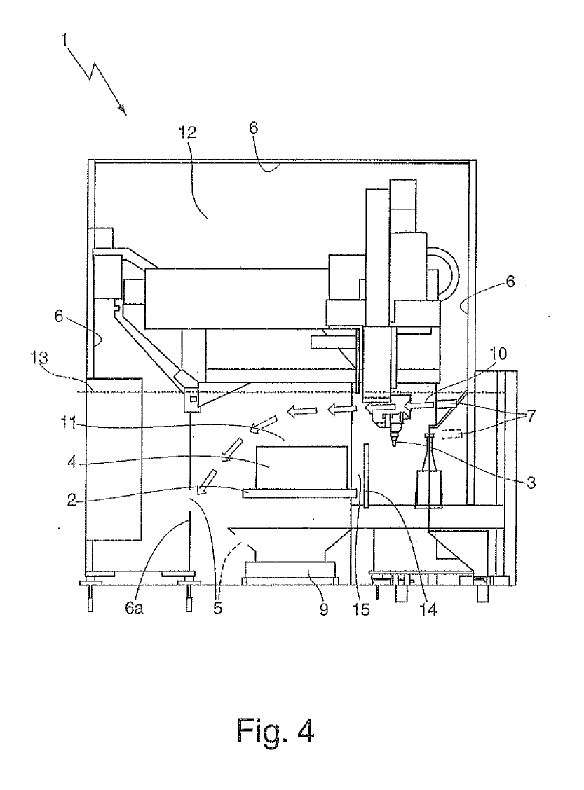

The laser machining system 1 shown in FIG. 4 differs from the laser machining system of FIG. 1 only in that the extraction opening 5 therein is not arranged transversely to the air flow band 10. Rather, the extraction opening 5 is arranged in the direction of the air flow band 10 on the side of the workpiece support 2 opposite to the inflow opening 7 in the region of the vertical enclosure portion 6a. As is shown by a broken line, the extraction opening 5 can alternatively be located on the (left-hand) longitudinal side of the waste container 9 facing the air inflow band 10.

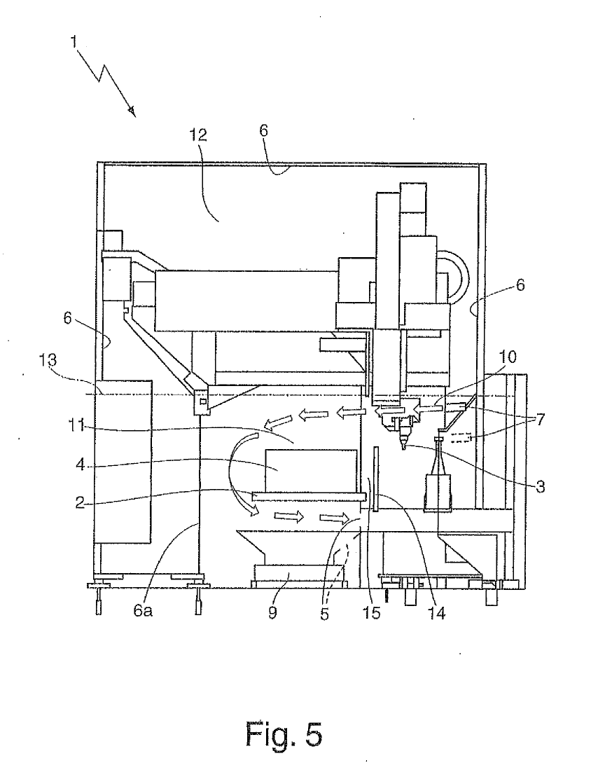

In a further embodiment according to FIG. 5, the extraction opening 5 is arranged beneath the workpiece support 2 on the same side as the inflow opening 7 and is open towards the deflected air inflow band 10. As is shown by a broken line, the extraction opening 5 can alternatively be located on the (right-hand) longitudinal side of the waste container 9 opposite to the deflected air inflow band 10.

In all the embodiments shown, multiple inflow openings 7 can be arranged next to one another at the same height, though only one is visible, for example, in FIGS. 1, 3, 4 and 5. Additionally, multiple extraction openings 5 can be arranged next to one another at the same height, though only one is visible in FIGS. 1, 3, 4 and 5. The inflow openings 7 and the extraction openings 5 can be activated individually or in combination to form a flow band 10 that has different widths and/or is in different positions. The opening or closing of individual extraction openings 5 may be based on the opening or closing of complementary air inflow openings 7 or vice versa. The openings 5, 7 can be activated based on, for example, the current position of the laser machining unit 3. The number of openings to be activated can be based on, for example, the particular application in question, such as the application process parameters and/or the material to be worked in the application.

As is shown by a broken line in FIG. 4, the inflow openings 7 and the extraction openings 5 can each be arranged in rows at different heights, which are then activated individually or in combination to form a flow band 10. Depending on the choice of activated openings, the flow band is positioned at different heights or is inclined downwards to different degrees.

A number of embodiments have been described. Nevertheless, it will be understood that various modifications may be made without departing from the spirit and scope of the invention. Accordingly, other embodiments are within the scope of the following claims.

1-20. (canceled)

21. A laser machining system comprising:
a workpiece support for workpieces to be machined;
a laser machining unit arranged above the workpiece support and for machining a workpiece located on the workpiece support;
at least one extraction opening beneath the workpiece support; and
an enclosure separating the workpiece support, the laser machining unit and the at least one extraction opening from an external environment, the enclosure comprising at least one air inflow opening,
wherein the at least one air inflow opening is arranged above the workpiece support and relative to the at least one extraction opening such that, during operation of the laser machining system, a pressure difference between the air inflow opening and the at least one extraction opening establishes a flow of air between the workpiece support and the laser machining unit, the flow of air separating the interior of the enclosure into a laser machining area beneath the flow of air and a laser free area above the flow of air, and
wherein at least a portion of the flow of air is slanted away from the air inflow opening and toward the at least one extraction opening.

22. The laser machining system according to claim 21, further comprising a displacement unit, wherein the laser machining unit is arranged on the displacement unit, the displacement unit being moveable along a direction that is parallel to a surface of the workpiece support for supporting the workpieces, and wherein the inflow opening is arranged between the bottom of the displacement unit and the workpiece support.

23. The laser machining system according to claim 21, wherein the inflow opening is moveable along a direction normal to the surface of the workpiece support.

24. The laser machining system according to claim 23, wherein the laser machining unit is moveable along the direction normal to the surface of the workpiece support, and wherein the laser machining system comprises a control device configured to adjust a position of the inflow opening along the direction normal to the surface of the workpiece support based on a position of the laser machining unit along the direction normal to the surface of the workpiece support.

25. The laser machining system according to claim 21, further comprising a deflection device arranged to deflect the flow of air into a circular flow that encloses the laser machining area.

26. The laser machining system according to claim 25, wherein the deflection device comprises at least one enclosure portion, at least one deflection plate, or a combination thereof inside the enclosure.

27. The laser machining system according to claim 21, wherein the at least one air inflow opening is arranged laterally next to the workpiece support.

28. The laser machining system according to claim 21, wherein the enclosure comprises a plurality of air inflow openings arranged at different heights or arranged next to one another at a same height, wherein the inflow openings are configured to be opened or closed individually or in one or more different combinations.

29. The laser machining system according to claim 21, wherein the at least one extraction opening and the at least one air inflow opening are arranged next to the workpiece support on a same side of the workpiece support or on opposite sides of the workpiece support.

30. The laser machining system according to claim 21, wherein the at least one extraction opening is open along a direction that is transverse to a propagation direction of the flow of air or in the propagation direction of the flow of air.

31. The laser machining system according to claim 21, comprising a plurality of extraction openings beneath the workpiece support, wherein the plurality of extraction openings are operable to be opened or closed individually or in one or more different combinations.

32. A laser machining system comprising:
a workpiece support for workpieces to be machined;
a laser machining unit arranged above the workpiece support and for machining a workpiece located on the workpiece support;
at least one extraction opening beneath the workpiece support;
a deflection device; and
an enclosure separating the workpiece support, the laser machining unit and the at least one extraction opening from an external environment, the enclosure comprising at least one air inflow opening,
wherein the at least one air inflow opening is arranged above the workpiece support and relative to the at least one extraction opening such that, during operation of the laser machining system, a pressure difference between the air inflow opening and the at least one extraction opening establishes a flow of air between the workpiece support and the laser machining unit, the flow of air separating the interior of the enclosure into a laser machining area beneath the flow of air and a laser free area above the flow of air, and
wherein the deflection device is arranged to deflect the flow of air to form a circular flow that encloses the laser machining area.

33. The laser machining system according to claim 32, wherein the deflection device comprises at least a portion of the enclosure portion or at least one deflection plate, or a combination thereof inside the enclosure.

34. The laser machining system according to claim 32, wherein the inflow opening is moveable along a direction normal to the surface of the workpiece support.

35. The laser machining system according to claim 34, wherein the laser machining unit is moveable along the direction normal to the surface of the workpiece support, and wherein the laser machining system comprises a control device configured to adjust a position of the inflow opening along the direction normal to the surface of the workpiece support based on a position of the laser machining unit along the direction normal to the surface of the workpiece support.

36. The laser machining system according to claim 32, wherein the at least one air inflow opening is arranged laterally next to the workpiece support.

37. The laser machining system according to claim 32, wherein the enclosure comprises a plurality of air inflow openings arranged at different heights or arranged next to one another at a same height, wherein the air inflow openings are configured to be opened or closed individually or in one or more different combinations.

38. The laser machining system according to claim 32, wherein the at least one extraction opening and the at least one air inflow opening are arranged next to the workpiece support on a same side of the workpiece support or on opposite sides of the workpiece support.

39. The laser machining system according to claim 32, wherein the at least one extraction opening is open along a direction that is transverse to a propagation direction of the flow of air or in the propagation direction of the flow of air.

40. The laser machining system according to claim 32, comprising a plurality of extraction openings beneath the workpiece support, wherein the plurality of extraction openings are operable to be opened or closed individually or in one or more different combinations.
